(19) United States
(12) Patent Application Publication
(10) Pub. No.: US 2021/0194298 A1
(43) Pub. Date: Jun. 24, 2021

(54) STATOR HOUSING FOR AN ELECTRIC MACHINE, ELECTRIC MACHINE, AND VEHICLE

(71) Applicant: VALEO SIEMENS EAUTOMOTIVE GERMANY GMBH, Erlangen (DE)

(72) Inventors: Philipp SÖNTGERATH, Niederkrüchten (DE); Nils KRAIS, Strahlungen (DE)

(21) Appl. No.: 17/123,406

(22) Filed: Dec. 16, 2020

(30) Foreign Application Priority Data
Dec. 19, 2019 (DE) 10 2019 135 139.1

(51) Int. Cl. H02K 1/20; H02K 9/19; H02K 5/20

(52) U.S. Cl. CPC H02K 1/20; H02K 5/203; H02K 9/19

(57) ABSTRACT

Stator housing for an electric machine, including an outer housing element and an inner housing element which is arranged inside the outer housing element. A cavity formed in the inner housing element and/or in the outer housing element forms a cooling channel between an inlet of the stator housing and an outlet of the stator housing for a cooling fluid. A gap between the housing elements which has a smaller radial extension than the cooling channel forms a fluid-conducting connection between the inlet and the outlet. The gap extends in the circumferential direction along a radial protrusion of a first housing element of the housing elements, which radial protrusion engages in a recess in a second housing element of the housing elements.

The present invention relates to a stator housing for an electric machine comprising an outer housing element and an inner housing element which is arranged inside the outer housing element, wherein a cavity formed in the inner housing element and/or in the outer housing element forms a cooling channel between an inlet of the stator housing and an outlet of the stator housing for a cooling fluid, wherein a gap between the housing elements which has a smaller radial extension than the cooling channel forms a fluid-conducting connection between the inlet and the outlet.

The invention also relates to an electric machine and a vehicle.

Electric machines heat up during their operation due to electrical losses in the windings of their stator. An unacceptably high temperature increase may lead to a thermal fault in the winding. In order to increase the utilisation of the electric machine, especially when used as a drive unit in a vehicle, it is known to provide a stator housing with two housing elements arranged one inside the other, between which a cavity forms a cooling channel. This is also known as a cooling jacket.

Such a stator housing is known, for example, from document WO 2006/106086 A1, which discloses an electric machine with a stator arranged in a housing. The housing has means for liquid cooling of the stator, wherein the housing consists of two flanges and a central housing portion placed in between.

The central housing portion has two sleeve-shaped elements coaxially arranged one inside the other, which, when fitted together, form a cooling jacket of the stator. In a region between the elements there are ribs, which are integrally connected to one element or the other. An inlet and an outlet are provided, so that a cooling liquid sweeps over the entire circumferential surface of the electric machine through the inlet, follows a meandering path via cooling channels, and exits at the outlet.

In such stator housings there is a gap between the housing elements due to manufacturing tolerances. In addition to the cooling channel, the gap creates a fluid-conducting connection between the inlet and the outlet. The larger the gap, the more the electric machine heats up during operation. It has already been proposed that the gap may be made smaller by further reducing the manufacturing tolerances. However, this is very complex and costly from a production viewpoint.

The object of the invention is therefore to describe an improved possibility of sealing a gap between an inlet and an outlet of a stator housing formed by two housing elements arranged one inside the other.

In order to achieve this object, it is proposed in accordance with the invention, in the case of a stator housing of the type mentioned at the outset, that the gap extends in the circumferential direction along a radial protrusion of a first housing element of the housing elements, which radial protrusion engages in a recess in a second housing element of the housing elements.

The invention is based on the consideration that the protrusion both extends an undesired flow path of the cooling fluid between the inlet and the outlet through the gap and increases a flow resistance along the undesired flow path by deflecting the flow path, with a flow resistance from the inlet to the outlet along the cooling channel remaining substantially unaffected. This reduces an average flow velocity along the gap, so that a smaller amount of the cooling fluid flows through the gap past the cooling channel. The concept according to the invention may therefore also be referred to as a hydraulic seal.

The stator housing according to the invention may therefore improve the cooling of the stator, since a smaller quantity of the cooling fluid flowing along the gap from the inlet to the outlet is removed from the cooling channel. At the same time, there is no need to reduce manufacturing tolerances of the housing elements, and therefore the stator housing may be manufactured without high additional effort or high additional costs.

The cooling channel typically has a radially inner interface formed by the inner housing element and a radially outer interface formed by the outer housing element. Interfaces of the cooling channel in the circumferential direction are typically realised by axial ribs of the inner housing element and/or the outer housing element. It is expedient to have the protrusion formed on a rib extending completely along the axial direction between the inlet and the outlet. Typically, the protrusion is provided in a short portion, with respect to the circumferential direction, between the inlet and the outlet. In general, in the stator housing according to the invention it may be provided that the cooling channel forms a fluid-conducting connection between the inlet and the outlet along a spatial direction with a predetermined orientation opposite an orientation of the fluid-conducting connection formed by the gap.

It is preferred in the stator housing according to the invention if the gap extends in the circumferential direction along a radial second protrusion of the second housing element, which radial second protrusion is preferably arranged on the outlet side with respect to the first protrusion and engages in a recess in the first housing element. In this way, an additional extension of the undesired flow path and an additional increase of the flow resistance may be provided.

To further extend the flow path, it may be provided that the gap extends in the circumferential direction along a radial third protrusion of the first housing element, which radial third protrusion is preferably arranged on the outlet side with respect to the second protrusion and engages in a second recess in the second housing element.

It is advantageously provided that the first protrusion and/or the third protrusion taper towards the second housing element. Alternatively or additionally, the second protrusion may be provided to taper towards the first housing element. A taper is particularly advantageous with regard to the production of the housing elements as cast parts, because this reduces the tendency for blowholes to form in the region of the protrusion, and the cast parts may be easily demolded. Of course, the, or a, recess in which the, or a, protrusion engages may also be tapered.

In advantageous embodiment, it is also provided that the second protrusion has a greater radial extension than the first protrusion and/or the third protrusion.

Preferably, the stator housing according to the invention is designed so that the, or each, protrusion extends along an axial direction.

Although it is, in essence, possible that the first housing element is the outer housing element and the second housing element is the inner housing element, it is preferred if the first housing element is the inner housing element and the second housing element is the outer housing element.

In the stator housing according to the invention, the cooling channel is preferably meandering. In this way, the stator may be cooled over as large an area as possible.

In particular, in the stator housing according to the invention it is provided that the cooling channel has main portions which define an axial flow direction of the cooling fluid and baffle portions each connecting a pair of adjacent main portions which reverse an orientation of the cooling fluid from one main portion of the pair to the other main portion of the pair.

To achieve a good seal in the axial direction, it is preferred if the inner housing element has a collar extending radially outwardly at one of its end faces and/or the outer housing element has a collar extending radially inwardly at one of its end faces. It is preferred if the, or a, collar extends radially further than the, or a, corresponding protrusion. It is expedient if the collars are provided at different end faces.

The problem addressed by the invention is further solved by an electric machine comprising a stator housing according to the invention and a stator arranged inside the inner housing element.

The electric machine typically also has a rotor mounted rotatably inside the stator.

In addition, the problem addressed by the invention is solved by a vehicle comprising an electric machine according to the invention, wherein the electric machine is designed to propel the vehicle. The vehicle may, for example, be an electric vehicle (BEV) or a hybrid vehicle.

Further advantages and details of the present invention will become clear from the embodiments described hereinafter and with reference to the drawings. These are schematic representations and show:

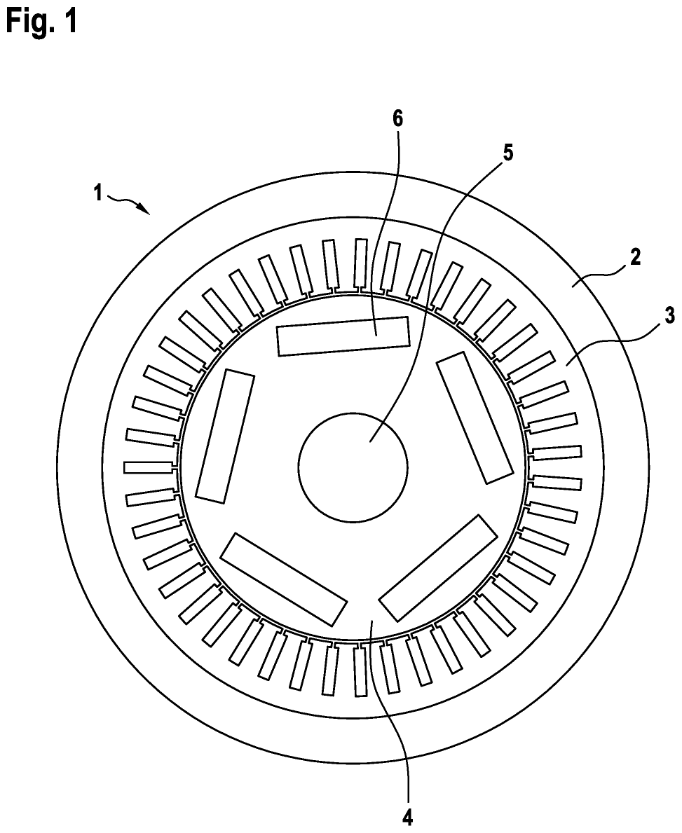

FIG. 1 a cross-sectional view of an embodiment of an electric machine according to the invention;

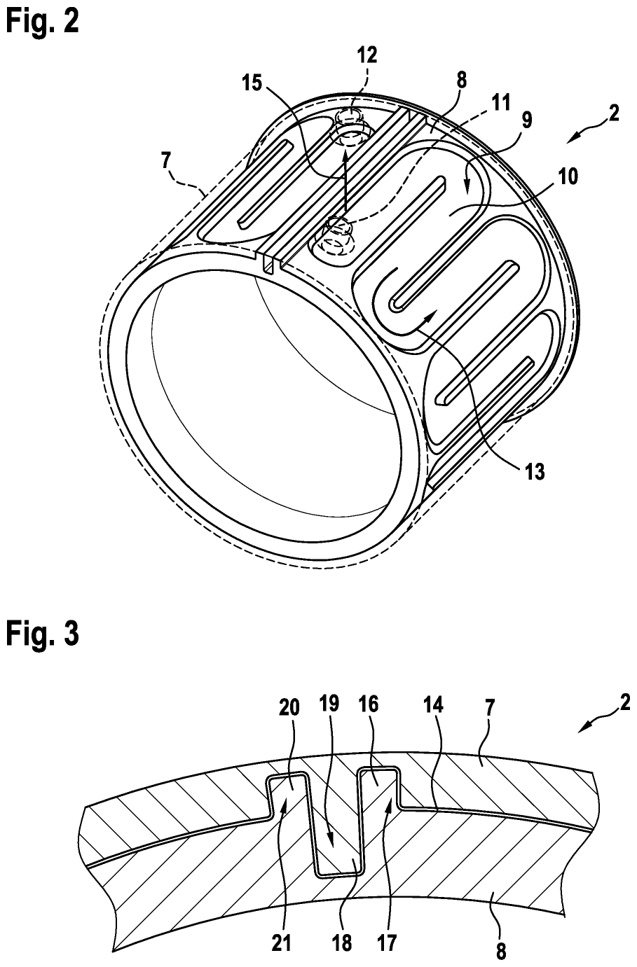

FIG. 2 a perspective view of a first embodiment of the stator housing according to the invention;

FIG. 3 a sectional detail of the stator housing according to the first embodiment;

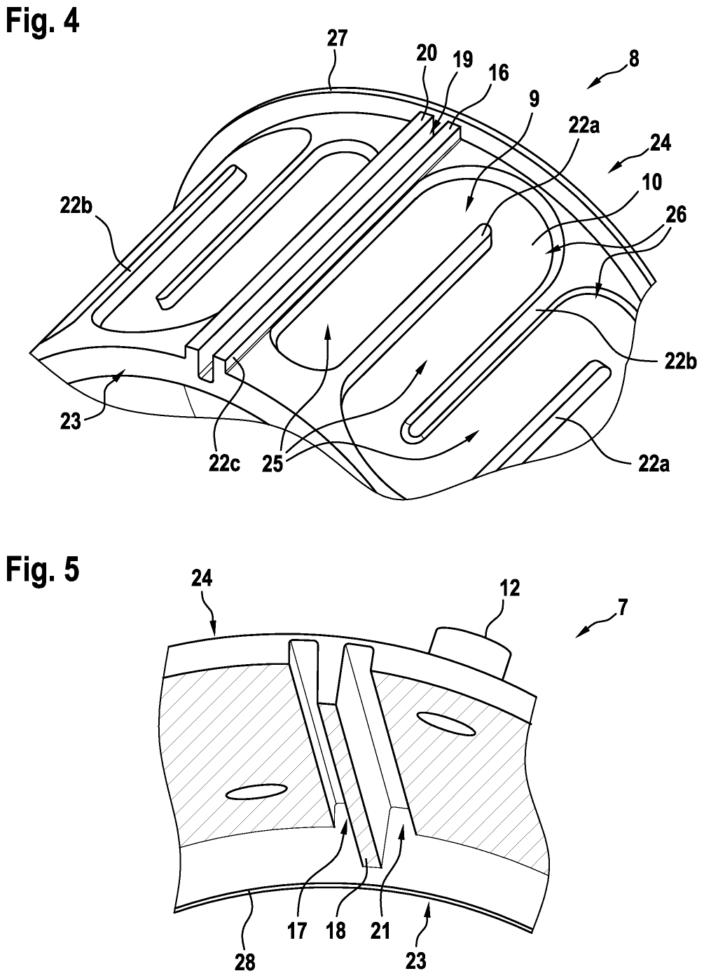

FIG. 4 a perspective detail of the inner housing element according to the first embodiment;

FIG. 5 a perspective detail of the outer housing element according to the first embodiment;

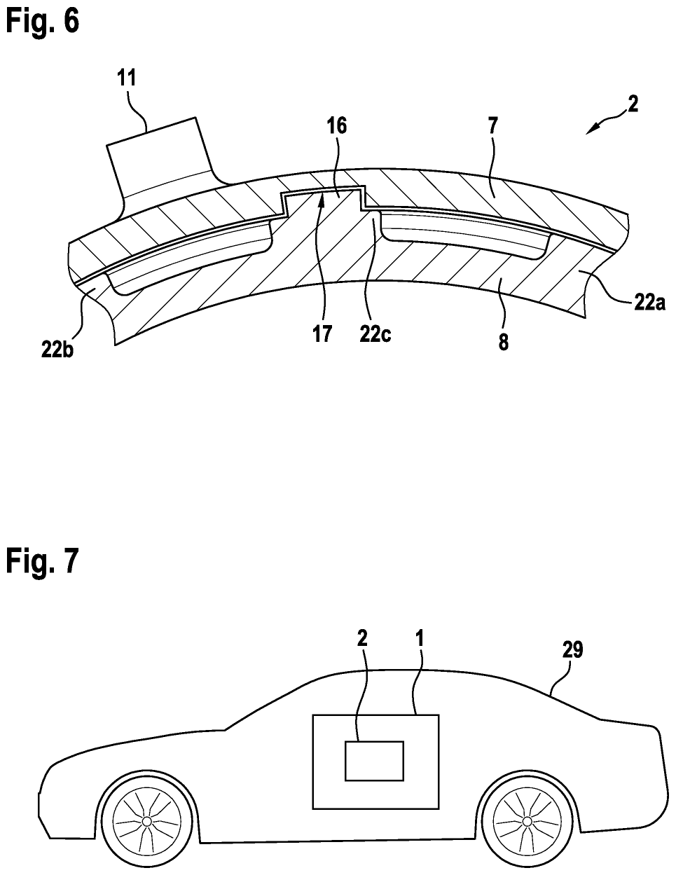

FIG. 6 a sectional detail of a second embodiment of the stator housing according to the invention; and

FIG. 7 a basic sketch of an embodiment of the vehicle according to the invention.

FIG. 1 is a cross-sectional view of an embodiment of an electric machine 1.

The electric machine 1 comprises a stator housing 2, a stator 3 which is connected to the stator housing 2, for example by means of a press fit, a rotor 4 which is arranged rotatably inside the stator 3, and a shaft 5, to which the rotor 4 is attached. As an example, the rotor 4 comprises a plurality of permanent magnets 6. The stator housing 2 corresponds to one of the embodiments described below.

FIG. 2 is a perspective view of a stator housing 2 according to a first embodiment.

The stator housing 2 comprises an outer housing element 7 and an inner housing element 8, which is located inside the outer housing element 7. A cavity 9 is formed in the inner housing element 8 and forms a meandering cooling channel 10 between an inlet 11 and an outlet 12 for a cooling fluid. In the present embodiment, the inlet 11 and the outlet 12 are formed on the outer housing element 7. An arrow 13 shows a main flow path of the cooling fluid along the cooling channel 10.

FIG. 3 is a sectional detail of the stator housing 2 according to the first embodiment.

Due to manufacturing tolerances, a gap 14 is formed between the housing elements 7, 8 and has a much smaller radial extension than the cooling channel 10 (see FIG. 2). Through this gap 14, a fluid-conducting connection between the inlet 11 and the outlet 12 (see FIG. 2) is formed. This gap 14 represents a basically undesirable flow path between the inlet 11 and the outlet 12 (shown in FIG. 2 by an arrow 15) which is opposite the main path.

As can be seen in FIG. 3, the gap 14 extends in the circumferential direction along a radial protrusion 16 of a first housing element of the housing elements 7, 8, which in this case is the inner housing element 8. The protrusion 16 engages in a recess 17 in a second housing element of the housing elements 7, 8, which in this case is the outer housing element 7. The gap 14 further extends along a radial second protrusion 18 of the second housing element 7, which radial second protrusion is arranged on the outlet side with respect to the first protrusion 16 and engages in a recess 19 in the first housing element 8, and along a radial third protrusion 20 of the first housing element 8, which radial third protrusion is arranged on the outlet side with respect to the second protrusion 18 and engages in a second recess 21 in the second housing element 7. The protrusions 16, 18, 20 extend the undesired flow path and thus increase its flow resistance. A reduction in volume flow along the undesired flow path achieved in this way may also be interpreted as a hydraulic seal.

The protrusions 16, 18, 20 are tapered towards the particular housing element 7, 8 in which they engage. The recesses 17, 19, 20 are correspondingly tapered, wherein a width of the gap 14 remains substantially unchanged. With regard to the production of the housing elements 7, 8 by a casting process, this facilitates the demoulding of a cast part and reduces the tendency for blowholes to form. As is shown, the second protrusion 18 has a greater radial extension than the protrusions 16, 20.

FIG. 4 is a perspective detailed view of the inner housing element 8 according to the first embodiment.

The inner housing element 8 has axial ribs 22a, 22b as a result of the formation of the cavity 9, wherein the ribs 22a extend incompletely in the axial direction from a first end face 23 towards a second end face 24 and the ribs 22b extend incompletely in the axial direction from the second end face 24 towards the first end face 23. The ribs 22a, 22b are arranged alternately in the circumferential direction. The protrusions 16, 20 and the recess 19 are formed on a rib 22c extending completely between the end faces 23, 24.

Through the cavity 9 or the ribs 22a, 22b, 22c, the cooling channel 10 has axial main portions 25 and deflection portions 26, which each connect a pair of adjacent main portions 25 and reverse the orientation of the cooling fluid of a main portion 25 of the pair with respect to the other main portion 25 of the pair.

At the second end face 24, a collar 27 is formed which extends radially outwardly and closes the stator housing 2 axially at the second end face 24.

FIG. 5 is a perspective detailed view of the outer housing element 7 according to the first embodiment.

In addition to the protrusion 18 and the recesses 17, 21, a further collar 28 can be seen, which extends radially inwardly at the first end face 23. The collar 28 closes the stator housing 2 axially at the first end face 23. The collars 27, 28 extend radially further inwardly and outwardly than the protrusions 16, 18, 20.

FIG. 6 is a sectional detail of a stator housing 2 according to a second embodiment. In this case, all variants of the first embodiment apply to the second embodiment with the exception of the deviation described below. Identical or similarly acting components are provided with identical reference signs.

In the second embodiment, only one protrusion 16 is provided on the rib 22c of the first housing element 8, which in turn engages in a single recess 17 in the second housing element 7. In this embodiment, both the protrusion 16 and the recesses 17 do not have a taper, but radial flanks.

In the following, simulation results of an operation of an electric machine 1 with a stator housing 2 according to the second embodiment will be presented in comparison to a conventional stator housing without the protrusion 16 and the recess 17. The simulation was based on a width of the gap 14 of 0.8 mm, a volume flow of 10 l·min⁻¹ and a temperature at the inlet 11 of 65° C. The following table shows simulation results for a maximum temperature and an average temperature at the inner housing element 8, for a maximum temperature and an average temperature at a press fit between stator housing 2 and stator 3, and a pressure drop between the inlet 11 and the outlet 12.

| | Conventional | Stator housing |
|---|---|---|
| | stator | according to the |
| | housing | second embodiment |
| Maximum temperature | 94.78° C. | 88.66° C. |
| Average temperature | 81.35° C. | 7780° C. |
| at the inner housing element | | |
| Maximum temperature | 94.89° C. | 88.66° C. |
| Average temperature | 86.19° C. | 82.22° C. |
| at the press fit | | |
| Pressure Drop | 1.19 kPa | 2.73 kPa |

As can be seen from the available simulation results, a significant reduction of the temperatures may be achieved. This is especially true for temperatures of local hotspots, which are described by the maximum temperatures. The increased pressure drop results on the one hand from the fact that the flow resistance in the desired main flow path remains substantially unchanged, and on the other hand from the fact that the flow resistance in the undesired flow path is considerably increased by the hydraulic seal.

FIG. 7 is a basic sketch of an embodiment of a vehicle 29, comprising the electric machine 1 with a stator housing 2 according to one of the embodiments described above. The electric machine 1 is designed to propel the vehicle 29. This is therefore an electric vehicle (BEV) or a hybrid vehicle.

1. Stator housing (2) for an electric machine (1), comprising an outer housing element (7) and an inner housing element (8) which is arranged inside the outer housing element (7), a cavity (9) formed in the inner housing element (8) and/or in the outer housing element (7) forming a cooling channel (10) between an inlet (11) of the stator housing (2) and an outlet (12) of the stator housing (2) for a cooling fluid, and a gap (14) between the housing elements (7, 8) which has a smaller radial extension than the cooling channel (10) forming a fluid-conducting connection between the inlet (11) and the outlet (12),
characterised in that
the gap (14) extends in the circumferential direction along a radial protrusion (16) of a first housing element (8) of the housing elements (7, 8), which radial protrusion engages in a recess (17) in a second housing element (7) of the housing elements (7, 8).

2. Stator housing according to claim 1, wherein
the protrusion (16) tapers towards the second housing element (7)

3. Stator housing according to claim 1, wherein
the gap (14) extends in the circumferential direction along a radial second protrusion (18) of the second housing element (7), which radial second protrusion engages in a recess (19) in the first housing element (8).

4. Stator housing according to claim 3, wherein
the second protrusion (18) tapers towards the first housing element (8).

5. Stator housing according to claim 3, wherein
the second protrusion (18) has a larger radial extension than the first protrusion (16).

6. Stator housing according to claim 1, wherein
the gap (14) extends in the circumferential direction along a radial third protrusion (20) of the first housing element (8), which radial third protrusion engages in a second recess (21) in the second housing element (7).

7. Stator housing according to claim 5, wherein
the third protrusion (20) tapers towards the second housing element (7).

8. Stator housing according to claim 1, wherein
the, or a, protrusion (16, 18, 20) extends along an axial direction.

9. Stator housing according to claim 1, wherein
the first housing element (8) is the inner housing element (8) and the second housing element (7) is the outer housing element (7).

10. Stator housing according to claim 1, wherein
the cooling channel (10) is meandering.

11. Stator housing according to claim 1, wherein
the cooling channel comprises main portions (25), which define an axial flow direction of the cooling fluid, and baffle portions (26), which each connect a pair of adjacent main portions (25) and reverse an orientation of the cooling fluid from one main portion (25) of the pair with respect to the other main portion (25) of the pair.

12. Stator housing according to claim 1, wherein
the inner housing element (8) has a collar (27) extending radially outwardly at one of its end faces (24) and/or the outer housing element (7) has a collar (28) extending radially inwardly at one of its end faces (23).

13. Stator housing according to claim 12, wherein
the, or a, collar (27, 28) extends radially further than the, or a, corresponding protrusion (16, 18, 20).

14. Electric machine (1) comprising a stator housing (2) according to claim 1 and a stator (3) arranged inside the inner housing element (8).

15. A vehicle (29) comprising an electric machine (1) according to claim 14, wherein the electric machine (1) is designed to propel the vehicle (29).
